(19) United States
(12) Patent Application Publication
(10) Pub. No.: US 2026/0311226 A1
(43) Pub. Date: Oct. 8, 2026

(54) METHOD AND APPARATUS FOR PROVIDING METADATA ENRICHMENTS IN ENTERPRISE DATA MANAGEMENT

(71) Applicant: Informatica LLC, Redwood City, CA (US)

(72) Inventors: Shaul ZEVIN, Har Adar (IL); Vishal BALAGANGADHAR, Bangalore (IN); Erman GUNGOR, San Carlos, CA (US); Derek PAULSEN, Madison, WI (US)

(21) Appl. No.: 19/169,448

(22) Filed: Apr. 3, 2025

(51) Int. Cl. G06Q 30/0601; G06F 16/28; G06F 40/40

(52) U.S. Cl. CPC G06Q 30/0603; G06F 16/288; G06F 40/40

(57) ABSTRACT

A method for automatically generating associations between technical assets and business assets in an enterprise catalog may include receiving information descriptive of a plurality of technical assets, receiving information descriptive of a plurality of business assets, determining relevant portions of the information descriptive of the plurality of technical assets and the information descriptive of a plurality of business assets, applying the relevant portions of the text descriptive of the plurality of technical assets and the text descriptive of a plurality of business assets to an LLM to determine technical asset to business asset associations, and enriching the enterprise catalog with determined technical asset to business asset associations.

### TECHNICAL FIELD

Example embodiments generally relate to enrichment of technical asset data via the provision of metadata enrichments.

### BACKGROUND

Within the context of enterprise data management, technical assets are structures used to store enterprise data. Examples of technical assets include databases, database schemas, schema tables, tables columns, structured files, etc. While certainly important to an enterprise, technical assets often represent a challenge for organization and management since they are digital resources whose meaning and relationships are not clear to the business user. In order to make management and organization of technical assets more accessible, association of the technical assets with a semantic layer of information that acts as metadata to create semantic or business assets that are associated with each respective one of the technical assets is desirable.

Metadata enrichments can create a semantic layer on top of the technical assets scanned into catalog. Broadly speaking, metadata enrichments can be partitioned into two types, which include semantic (business) asset creation (e.g., business terms creation) and association of semantic (business) assets to the technical assets (e.g., association of a relational table column with a business term). Both creation and association of business assets is done either manually or by user created rules. The manual process is time-consuming, suffers from inconsistency and is both error prone and hard to maintain. Furthermore, manual processing can cover only a tiny part of the existing associations as millions of technical assets that may need to be associated for a large (enterprise) organization. Business assets creation and association rules are solely based on the technical assets syntactic features, such as relational column name. Creation of such rules can be challenging and requires expertise the user may not have. In this regard, the creation of a regular expression over column names for column to data classification association may illustrate one example. In practice, such rules results have a very low precision with a high percentage of false positives. Therefore, results of such rules cannot be used directly and require time consuming human curation to filter out false inferences.

FIG. 1 illustrates how the associations of technical assets with business assets has been accomplished in the past. In this regard, as shown in FIG. 1, the process generally begins with a catalog administrator 100, which is an individual charged with making association rules 110, which associate business assets to technical assets. After applying the association rules to a data set including technical assets, an association set 120 is generated. The association set 120 includes all of the business asset to technical asset associations that have been generated based on the application of the association rules 110. The catalog administrator 100 then engages in a curation operation 130. As a result of this curation, the curated associations can be uploaded into a catalog 140. The catalog 140 may include a metadata catalog layer 142 that has corresponding associations made to a semantic catalog layer 144. An improvement upon this situation is highly desirable.

### BRIEF SUMMARY OF SOME EXAMPLES

Some example embodiments of the present invention provide a method and apparatus for employing the power of large language models (LLMs) to create semantic (business) assets and to associate them with technical assets.

In one example embodiment, a method for automatically generating associations between technical assets and business assets in an enterprise catalog may be provided. The method may include receiving information descriptive of a plurality of technical assets, receiving information descriptive of a plurality of business assets, determining relevant portions of the information descriptive of the plurality of technical assets and the information descriptive of a plurality of business assets, applying the relevant portions of the text descriptive of the plurality of technical assets and the text descriptive of a plurality of business assets to an LLM to determine technical asset to business asset associations, and enriching the enterprise catalog with determined technical asset to business asset associations.

In another example embodiment, an apparatus for automatically generating associations between technical assets and business assets in an enterprise catalog may be provided. The apparatus may include processing circuitry configured for receiving information descriptive of a plurality of technical assets, receiving information descriptive of a plurality of business assets, determining relevant portions of the information descriptive of the plurality of technical assets and the information descriptive of a plurality of business assets, applying the relevant portions of the text descriptive of the plurality of technical assets and the text descriptive of a plurality of business assets to an LLM to determine technical asset to business asset associations, and generating the enterprise catalog based on the determined technical asset to business asset associations.

In still another example embodiment, a computer program product embodied on a non-transitory computer readable medium may be provided. The computer program product may include computer code that when executed causes execution of operations including receiving information descriptive of a plurality of technical assets, receiving information descriptive of a plurality of business assets, determining relevant portions of the information descriptive of the plurality of technical assets and the information descriptive of a plurality of business assets, applying the relevant portions of the text descriptive of the plurality of technical assets and the text descriptive of a plurality of business assets to an LLM to determine technical asset to business asset associations, and generating the enterprise catalog based on the determined technical asset to business asset associations.

### BRIEF DESCRIPTION OF THE SEVERAL VIEWS OF THE DRAWING(S)

Having thus described some embodiments of the present invention in general terms, reference will now be made to the accompanying drawings, which are not necessarily drawn to scale, and wherein:

FIG. 1 illustrates a prior art process of human curated associations between business assets and technical assets;

FIG. 2 illustrates a system architecture for providing high precision semantic layer creation in a fully automated way according to an example embodiment;

FIG. 3 illustrates a listing of semantic assets of a catalog according to an example embodiment;

FIG. 4 illustrates a listing of business assets of a catalog according to an example embodiment;

FIG. 5 illustrates an LLM assignment table generated according to an example embodiment;

FIG. 6 illustrates an apparatus for providing high precision semantic layer creation in a fully automated way according to an example embodiment; and

FIG. 7 illustrates a flowchart of a method for providing high precision semantic layer creation in a fully automated way according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability, or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, the phrase “operable coupling” and variants thereof should be understood to relate to direct or indirect connection that, in either case, enables functional interconnection of components that are operably coupled to each other.

As used in herein, the term “module” is intended to include a computer-related entity, such as but not limited to hardware, firmware, or a combination of hardware and software (i.e., hardware being configured in a particular way by software being executed thereon). For example, a module may be, but is not limited to being, a process running on a processor, a processor (or processors), an object, an executable, a thread of execution, and/or a computer. By way of example, both an application running on a computing device and/or the computing device can be a module. One or more modules can reside within a process and/or thread of execution and a module may be localized on one computer and/or distributed between two or more computers. In addition, these components can execute from various computer readable media having various data structures stored thereon. The modules may communicate by way of local and/or remote processes such as in accordance with a signal having one or more data packets, such as data from one module interacting with another module in a local system, distributed system, and/or across a network such as the Internet with other systems by way of the signal. Each respective module may perform one or more functions that will be described in greater detail herein. However, it should be appreciated that although this example is described in terms of separate modules corresponding to various functions performed, some examples may not necessarily utilize modular architectures for employment of the respective different functions. Thus, for example, code may be shared between different modules, or the processing circuitry itself may be configured to perform all of the functions described as being associated with the modules described herein. Furthermore, in the context of this disclosure, the term “module” should not be understood as a nonce word to identify any generic means for performing functionalities of the respective modules. Instead, the term “module” should be understood to be a component that is specifically configured in, or can be operably coupled to, the processing circuitry to modify the behavior and/or capability of the processing circuitry based on the hardware and/or software that is added to or otherwise operably coupled to the processing circuitry to configure the processing circuitry accordingly.

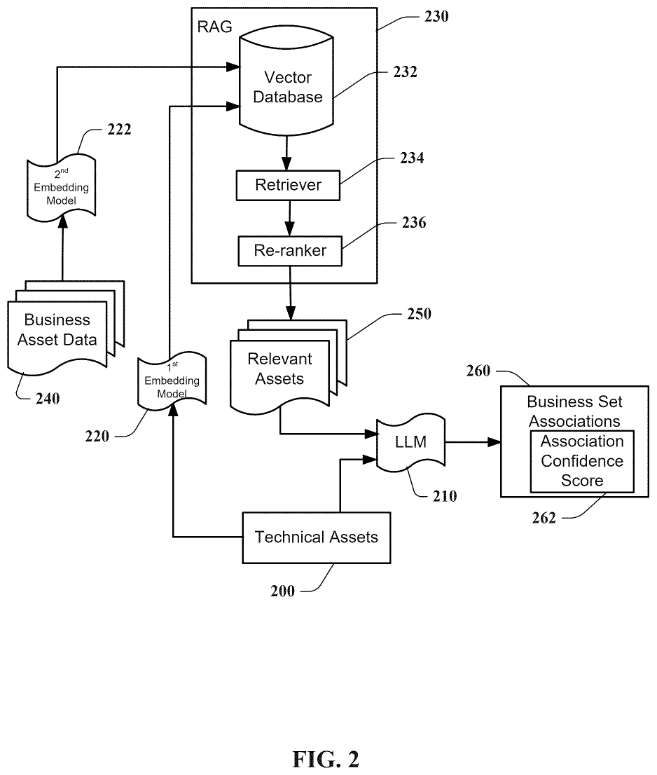

As noted above, example embodiments may provide a method and apparatus for employing the power of large language models (LLMs) to create semantic (business) assets and to associate them with technical assets. Example embodiments are useful when, for example, an enterprise has a catalog of technical assets (e.g., electronic assets such as databases, tables, columns therein or other structured files) that include descriptions that are not recognizable to a business user, and would therefore benefit the business user greatly if they could be correlated to business assets in terms the business user would understand. As an example, the term customer may be used in a column in a database or table, but the business user may be used to referring to a client instead of a customer. This semantic difference may cause a business user to formulate a query that would not get a useful response from the catalog. Thus, a correlation between the technical assets and business assets may enable business users to get more useful interaction from the catalog. FIG. 2 illustrates a system architecture for replacing manual and rule based semantic layer creation with an apparatus capable of providing high precision semantic layer creation in a fully automated way.

In this regard, for example, a set of data including or listing all technical assets 200 of an organization may be provided to an LLM 210. The technical assets 200 may include all of the locations and places where customers store data. Thus, the technical assets 200 may include databases, schema, tables, actual personal data, and many other digital resources of the organization. The set of data in the technical assets 200 may therefore be understood to include many millions of pieces of data.

The LLM 210 may initially be a generic LLM, but the LLM 210 is to be refined for making the specific connections that will implement the processes of example embodiments. This refinement is enhanced by various preprocessing operations that condition data and associations prior to exposure to the LLM 210, since LLMs cannot generally process text, and instead process numbers. Moreover, LLMs are generally limited by the length of any instruction (e.g., text prompt) that they are given. In this regard, for example, the set of data of the technical assets 200 may also be provided to a first embedding model 220, which may condition the set of data defining the technical assets 200 prior to processing by a Retrieval-Augmented Generation (RAG) module 230.

The RAG module 230 may be an artificial intelligence (AI) tool that enhances accuracy and relevance of LLM responses by integrating external knowledge sources to ground the LLM's output in real-world information that is relevant to the problem at hand. The RAG module 230 therefore facilitates dealing with the limitations of LLMs by finding various similar things to permit comparison of the similar things in a particular context, which ultimately optimizes the output of the LLM 210. In an example embodiment, the RAG module 230 may include a vector database 232, a retriever 234 and a re-ranker 236, which will be discussed in greater detail below. The RAG module 230 may, for example, provide a filtering function on the data provided thereto in order to focus the relevance of data that is ultimately provided to the LLM 210 for making the associations between business assets and technical assets.

The RAG module 230 may also receive business asset data 240, which corresponds to customer data identifying potentially thousands of business assets. The business asset data 240 may include listings of business assets from various policy documents, customer documents such as wiki notes, or various other examples of business assets. However, like the set of data defining the technical assets 200, the business asset data 240 may also require preconditioning via a second embedding model 222. The RAG module 230 is used to extend LLM prompt with context information such as relevant semantic (business) assets and chunks of documents relevant for the task. As an example, business term candidates for the association to column can be retrieved from the vector database 232 by a vector search with a column embedding vector. As another example, chunks of SAP manual are retrieved for SAP columns metadata enrichments by a keyword search. SAP columns have cryptic names and cannot be enriched directly.

The first and second embedding models 220 and 222 may each be configured to convert text information into vectors as an enabling function for the RAG module 230. The conversion into vectors is intended to preserve the meaning of the data that is converted, but place the data into a form (i.e., numerical form) that can ultimately be understood and processed by the LLM 210. The vector output of the first and second embedding models 220 and 222 may therefore be understood to provide a description of each respective piece of data (e.g., business assets and technical assets) in a vector format that permits comparison for the purposes of identifying similarities.

The vector database 232 may store vectors of the business asset data 240 and the technical assets 200 for comparison by the retriever 234. In this regard, the retriever 234 may be configured to compare the vectors of the business asset data 240 and the technical assets 200 to find similarities therebetween. In some cases, the retriever 234 may provide similarity scores to provide a basis for considering how similar compared vectors are. The re-ranker 236 may look at the results of the retriever 234 to identify (e.g., rank) the results that appear to be most similar (e.g., have the highest similarity scores). The similar results may be considered to be relevant assets 250, which may be provided to the LLM 210. The relevant assets 250 may include chunks of relevant business assets and customer documents along with technical assets that have high similarity scores. The LLM 210 may then generate a listing of technical asset to business asset associations 260. Moreover, in some examples, the LLM 210 may further provide an association confidence score 262 for each association made.

The pre-processing of data prior to provision to the LLM 210, may be a part of a process to fine tune the LLM 210 with examples of semantic (business) assets and their associations to the technical assets. In particular, the LLM 210 is fine-tuned to create business descriptions of technical assets, expand abbreviated technical assets names, create and associate business terms, create and associate data classifications, create data quality rules for the technical assets, label technical assets, etc. In relation to labeling, for example, the LLM 210 may label technical assets that include personal information (PI), personally identifiable information (PII), and protected health information (PHI).

The fine-tuning of the LLM 210 may, in some cases, be further assisted or performed using low rank adaptation (LoRA) technology. LoRA is a technique that allows for efficient fine-tuning of LLMs by adapting only a small subset of the model's parameters, rather than retraining the entire model. The use of LoRA is therefore both faster and more cost-effective, and enables using an open source LLM for the LLM 210. Using an open source LLM for the LLM 210 also minimizes the metadata enrichments cost and eliminates security concerns associated with exposing customer metadata to a third party.

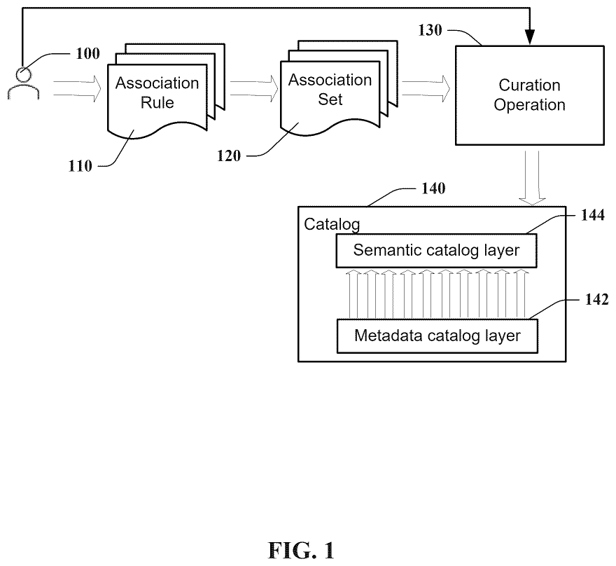

The fine-tuning of the LLM 210 may effectively engineer the extension of the LLM prompt with rich sematic context. The LLM prompt may also extended with context of relevant technical assets. As an example, for creation of a business description of a column in a relational table, other columns in the table may also be added to the prompt. The LLM prompt may also be extended with an industry domain such as, for example, finance, insurance or healthcare. In some cases, the LLM prompt may also be extended with data profiling information such as, for example, frequent data values and patterns. The fine-tuned LLM (i.e., LLM 210) can therefore replace the manual and rule based semantic layer creation process described above in connection with FIG. 1. The semantic layer creation of the example of FIG. 2 is completely automated by the LLM inference process described above. The LLM inference process executed by the LLM 210 therefore represents a high precision metadata enrichment process that can be accompanied by the result confidence score (e.g., association confidence score 262) to significantly shorten the way for results acceptance into the catalog.

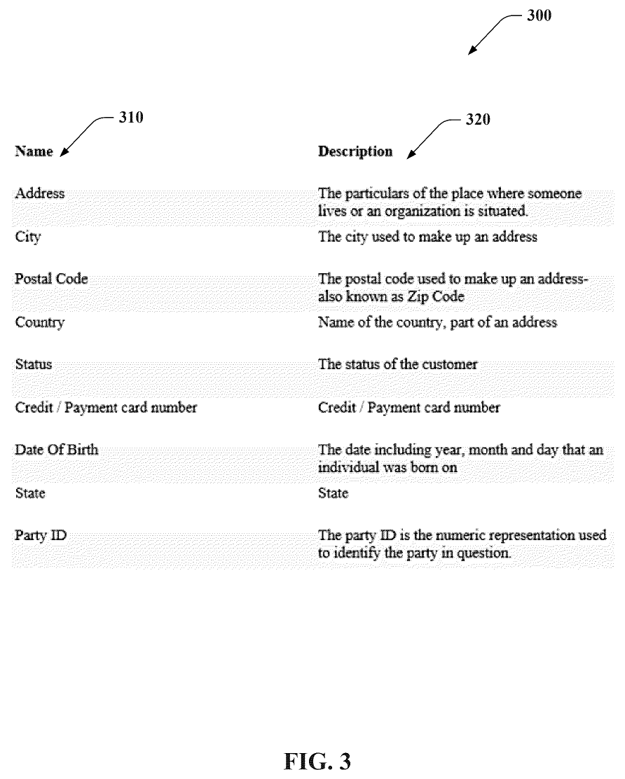

FIG. 3 illustrates a listing of semantic assets 300 from a catalog. In this regard, the listing of semantic assets 300 of FIG. 3 includes business terms in name column 310. Each of the business terms from the name column 310 may have a corresponding text description in a description column 320. As noted above, the second embedding model 220 may convert each business term into a vector.

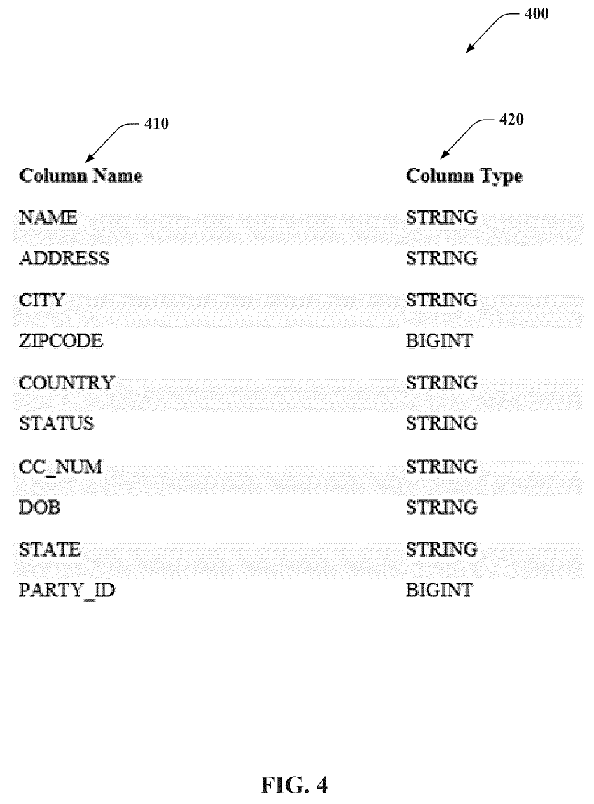

Turning to FIG. 4, a listing of technical assets 400 from a catalog is illustrated. The listing of technical assets 400 includes a name column 410, which lists characters defining a name from data associated with a technical asset. The type column 420 provides a data type identifier for the data stored in the column 410. In this example, some technical asset data types are numeric, and other technical asset data types are strings that can have variable lengths of characters. As noted above, the first embedding model 220 may convert each business term into a vector.

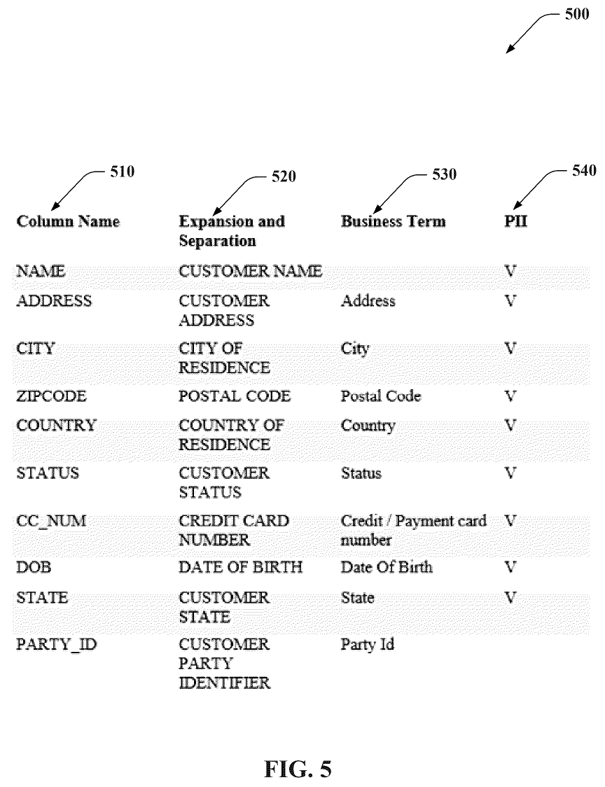

The contents of both FIGS. 3 and 4 may be processed by the RAG module 230 to find vector similarities, and the LLM 210 may generate an outcome similar to that shown in FIG. 5. In this regard, the results of FIG. 5 may be an example of the listing of technical asset to business asset associations 260 shown in FIG. 2. FIG. 5 may illustrate an LLM assignment table 500, which includes a name column 510, an expansion and separation column 520, a business term column 530 and a label column 540. In this example, the LLM 210 has expanded and separated the column names relative to the inputs provided. In some examples, the expansion and separation may allow text indexing of column names by a full-text search engine (e.g., Lucene). The expansion may allow for associations to be made that might otherwise have been missed, by including additional information (e.g., context) that provides additional meaning to permit associations based on meaning and beyond mere correspondence of text characters. The name column 510 therefore provides the names of technical assets that have been associated (by placement in the same row) with business terms from the business term column 530. The expansion and separation column 520 includes additional text description of what the associated business terms and technical asset terms mean. Finally, the label column 540 includes additional information or labels that may apply to each associated set of terms. In this example, the labeling was for PII, and a checkmark in the column for each associated row of data means that the associated terms are or include PII. Of note, the ZIPCODE or Postal Code is, by itself, merely public data that is very generic. However, when provided in the context of customer data, the ZIPCODE or Postal Code is actually PII, and the LLM 210 has correctly made that distinction.

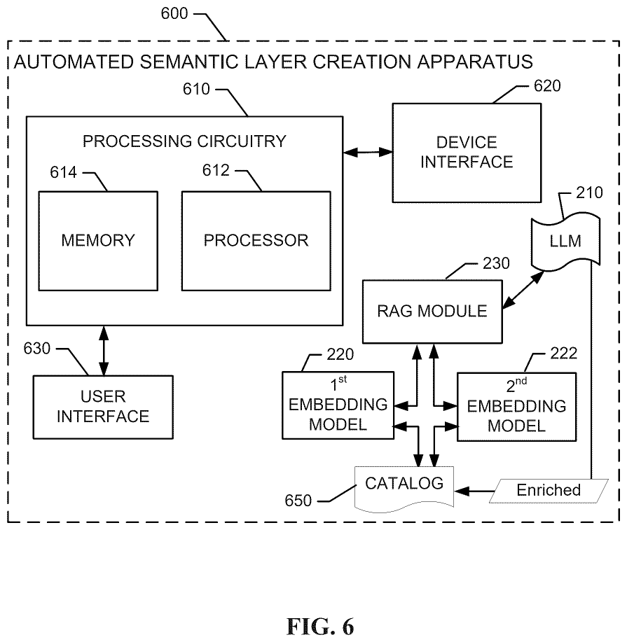

FIG. 6 illustrates an apparatus 600 for providing high precision semantic layer creation in a fully automated way according to an example embodiment. Referring to FIG. 6, the apparatus 600 may include processing circuitry 610 associated with a computing device that may include one or more instances of a processor 612 and a memory 614 along with a device interface 620. The device interface 620 may include a bus network that may provide communication between the various components of the computing device, such as a user interface 630 (e.g., including an input controller and an output controller), and one or more communication connections to networked computing devices. As shown in FIG. 6, the apparatus 600 may include, host, store, execute or otherwise enable operation of the LLM 210, the RAG module 230, and the first and second embedding models 220 and 222.

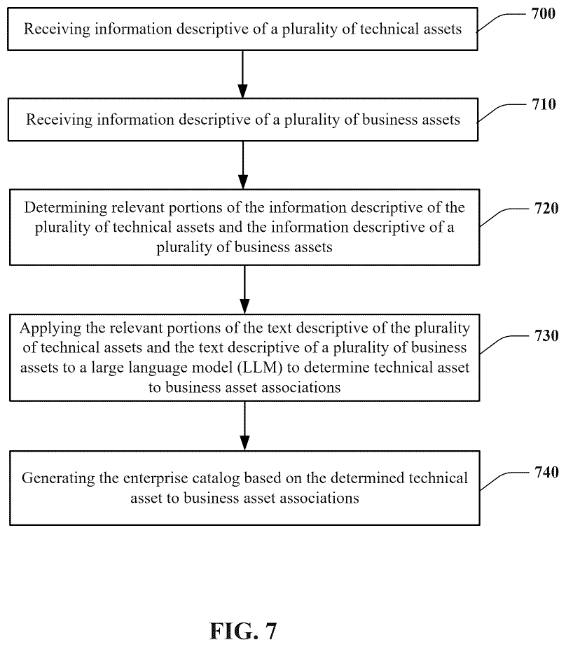

The processor 612 may execute computer-executable instructions and can be a real or a virtual processor. In some embodiments, multiple processors may execute computer-executable instructions concurrently to increase processing power. In some cases, the processor 612 (or the processing circuitry 610) may be embodied as, or include, a graphics processing unit (GPU) specialized for rapid processing and efficient operation in an AI environment. The memory 614 may include volatile memory (e.g., registers, cache, RAM), non-volatile memory (e.g., ROM, flash memory, etc.), or a combination thereof. The memory 614 may be non-transitory, and may store software instructions for executing the methods described herein (e.g., in reference to FIG. 7 below) when executed by the processor 612.

The user interface 630 may facilitate input via various input devices such as a keyboard, mouse, or touchscreen. The user interface 630 may also manage output to one or more output devices such as a display, printer, or speakers. The one or more communication connections of the device interface may enable communication over wired or wireless media, connecting the computing device to other entities, such as cloud servers, local databases, or networked devices.

It will be appreciated that the apparatus 600 may operate in various configurations, including distributed computing environments where components such as the processor 612 and memory 614 are spread across multiple physical devices. This allows the methods described in reference to FIG. 7 to be implemented in a wide range of environments, including standalone systems or cloud-based networks. The methods described herein may be executed using computer-readable media, which can include the memory 614, other storage device, and communication media. In particular, a catalog 650 may include the business asset data and technical asset data, which is processed in order to enrich the catalog 650 via the LLM as described above and in connection with FIG. 7.

FIG. 7 illustrates a flowchart of a method for providing high precision semantic layer creation in a fully automated way according to an example embodiment. The method may, when executed, automatically generate associations between technical assets and business assets in an enterprise catalog. The method may include receiving information descriptive of a plurality of technical assets at operation 700, receiving information descriptive of a plurality of business assets at operation 710, determining relevant portions of the information descriptive of the plurality of technical assets and the information descriptive of a plurality of business assets at operation 720, applying the relevant portions of the text descriptive of the plurality of technical assets and the text descriptive of a plurality of business assets to an LLM to determine technical asset to business asset associations at operation 730, and enriching the enterprise catalog with determined technical asset to business asset associations at operation 740. The enrichment may effectively include regeneration or augmentation of the catalog 650 based on the associations providing metadata enrichment described above. Notably, in some examples, all of the technical assets may be received and converted to vectors and stored in the vector database 232. The information descriptive of business assets may then include one or more queries relating to a business asset, which is also modeled and converted into a vector. That vector may be compared to the stored vectors, but not stored in the vector database itself. Thus, in the example noted above, the term “customer” may be in a column of the technical assets and converted to a vector and stored in the vector database 232 along with the rest of the technical assets. When a business user enters a query for the business term “client,” the term (and/or any other query terms) may also be converted to a vector, not necessarily for storage, but for comparison to the stored vectors prior to ultimate processing for the associations made by the LLM 210 described above. The association made by the LLM 210 may then cause the query to return a response including technical assets from the column “customer” instead of returning nothing, which would otherwise be a frustrating and inaccurate response.

It may be noted that the flowchart of FIG. 7 is explained to have above stated steps; however, those skilled in the art would appreciate that the flowchart may have more/less number of steps which may enable all the above stated embodiments of the present disclosure. While the above-described flowchart outlines an example method for providing high precision semantic layer creation in a fully automated way, it should be understood that these methods may be implemented in or involve one or more computing systems. FIG. 6 illustrates an example of a computing environment in which these methods may be executed. It will be appreciated that the computing environment is provided as an example and is not intended to suggest any limitation as to the scope of use or functionality of a described embodiment.

In some embodiments, the method of FIG. 7 (and a corresponding apparatus or system configured to perform the operations of the method) may include (or be configured to perform) additional components/modules, optional operations, and/or the components/operations described above may be modified or augmented. Some examples of modifications, optional operations and augmentations are described below. It should be appreciated that the modifications, optional operations and augmentations may each be added alone, or they may be added cumulatively in any desirable combination. In an example embodiment, determining relevant portions of the information descriptive of the plurality of technical assets and the information descriptive of a plurality of business assets may include converting text descriptive of the plurality of technical assets into a first vector set, and converting text descriptive of the plurality of business assets into a second vector set. In an example embodiment, determining relevant portions of the information descriptive of the plurality of technical assets and the information descriptive of a plurality of business assets may further include finding similarities associated with the first vector set and the second vector set based on comparisons of vectors of the first and second vector sets. In some cases, the relevant portions may be determined based on a similarity score associated with the comparisons. In an example embodiment, determining relevant portions of the information descriptive of the plurality of technical assets and the information descriptive of a plurality of business assets may include applying Retrieval-Augmented Generation (RAG) technology to text descriptive of the plurality of technical assets and text descriptive of the plurality of business assets. In some cases, the RAG technology is used to extend an LLM prompt with context information or labels for technical assets, with industry domain information, or with data profiling information. In an example embodiment, the LLM may be an open source LLM that is fine-tuned via Low-Rank Adaptation (LoRA).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits, or solutions to problems are described herein, it should be appreciated that such advantages, benefits, and/or solutions may be applicable to some example embodiments, but not necessarily all example embodiments. Thus, any advantages, benefits, or solutions described herein should not be thought of as being critical, required, or essential to all embodiments or to that which is claimed herein. Although specific terms are employed herein, they are used in a generic and descriptive sense only and not for purposes of limitation.

1. A method for automatically generating associations between technical assets and business assets in an enterprise catalog, the method comprising:
receiving information descriptive of a plurality of technical assets;
receiving information descriptive of a plurality of business assets;
determining relevant portions of the information descriptive of the plurality of technical assets and the information descriptive of a plurality of business assets based on a similarity score associated with comparing the information descriptive of the plurality of technical assets and the information descriptive of the plurality of business assets being above a predetermined amount;
applying only the relevant portions of the information descriptive of the plurality of technical assets and the information descriptive of a plurality of business assets to a large language model (LLM) to determine technical asset to business asset associations; and
enriching the enterprise catalog with determined technical asset to business asset associations.

2. The method of claim 1, wherein determining relevant portions of the information descriptive of the plurality of technical assets and the information descriptive of a plurality of business assets comprises:
converting text of the information descriptive of the plurality of technical assets into a first vector set; and
converting text of the information descriptive of the plurality of business assets into a second vector set.

3. The method of claim 2, wherein determining relevant portions of the information descriptive of the plurality of technical assets and the information descriptive of a plurality of business assets further comprises finding similarities associated with the first vector set and the second vector set based on comparisons of vectors of the first and second vector sets.

4. (canceled)

5. The method of claim 1, wherein determining relevant portions of the information descriptive of the plurality of technical assets and the information descriptive of a plurality of business assets comprises applying Retrieval-Augmented Generation (RAG) technology to the information descriptive of the plurality of technical assets and the information descriptive of the plurality of business assets.

6. The method of claim 5, wherein the RAG technology is used to extend an LLM prompt with context information or labels for technical assets.

7. The method of claim 5, wherein the RAG technology is used to extend an LLM prompt with industry domain information.

8. The method of claim 5, wherein the RAG technology is used to extend an LLM prompt with data profiling information.

9. The method of claim 1, wherein the LLM is an open source LLM that is fine-tuned via Low-Rank Adaptation (LoRA).

10. An apparatus for automatically generating associations between technical assets and business assets in an enterprise catalog, the apparatus comprising processing circuitry configured to:
receive information descriptive of a plurality of technical assets;
receive information descriptive of a plurality of business assets;
determine relevant portions of the information descriptive of the plurality of technical assets and the information descriptive of a plurality of business assets based on a similarity score associated with comparing the information descriptive of the plurality of technical assets and the information descriptive of the plurality of business assets being above a predetermined amount;
apply only the relevant portions of the information descriptive of the plurality of technical assets and the information descriptive of a plurality of business assets to a large language model (LLM) to determine technical asset to business asset associations; and
enrich the enterprise catalog with determined technical asset to business asset associations.

11. The apparatus of claim 10, wherein determining relevant portions of the information descriptive of the plurality of technical assets and the information descriptive of a plurality of business assets comprises:
converting text of the information descriptive of the plurality of technical assets into a first vector set; and
converting text of the information descriptive of the plurality of business assets into a second vector set.

12. The apparatus of claim 11, wherein determining relevant portions of the information descriptive of the plurality of technical assets and the information descriptive of a plurality of business assets further comprises finding similarities associated with the first vector set and the second vector set based on comparisons of vectors of the first and second vector sets.

13. (canceled)

14. The apparatus of claim 10, wherein determining relevant portions of the information descriptive of the plurality of technical assets and the information descriptive of a plurality of business assets comprises applying Retrieval-Augmented Generation (RAG) technology to the information descriptive of the plurality of technical assets and the information descriptive of the plurality of business assets.

15. The method of claim 14, wherein the RAG technology is used to extend an LLM prompt with context information or labels for technical assets.

16. The method of claim 14, wherein the RAG technology is used to extend an LLM prompt with industry domain information.

17. The method of claim 14, wherein the RAG technology is used to extend an LLM prompt with data profiling information.

18. The method of claim 10, wherein the LLM is an open source LLM that is fine-tuned via Low-Rank Adaptation (LoRA).

19. A computer program product embodied on a non-transitory computer readable medium, comprising computer code that when executed causes execution of operations including:
receiving information descriptive of a plurality of technical assets;
receiving information descriptive of a plurality of business assets;
determining relevant portions of the information descriptive of the plurality of technical assets and the information descriptive of a plurality of business assets based on a similarity score associated with comparing the information descriptive of the plurality of technical assets and the information descriptive of the plurality of business assets being above a predetermined amount;
applying only the relevant portions of the information descriptive of the plurality of technical assets and the information descriptive of a plurality of business assets to a large language model (LLM) to determine technical asset to business asset associations; and
enriching the enterprise catalog with determined technical asset to business asset associations.

20. The computer program product of claim 19, wherein determining relevant portions of the information descriptive of the plurality of technical assets and the information descriptive of a plurality of business assets comprises:
converting text of the information descriptive of the plurality of technical assets into a first vector set; and
converting text of the information descriptive of the plurality of business assets into a second vector set.
